(19) United States
(12) Patent Application Publication
(10) Pub. No.: US 2005/0027652 A1
(43) Pub. Date: Feb. 3, 2005

(54) Systems and methods for enhanced accounts

(76) Inventors: Eric Miller Reeves, Raleigh, NC (US); Steven George Saltzman, Durham, NC (US)

Correspondence Address: KILPATRICK STOCKTON LLP, 1001 WEST FOURTH STREET, WINSTON-SALEM, NC, 27101, US

(21) Appl. No.: 10/894,211

(22) Filed: Jul. 19, 2004

Related U.S. Application Data
(60) Provisional application No. 60/488,245, filed on Jul. 18, 2003.

(51) Int. Cl. G06F 17/60

(52) U.S. Cl. 705/39

(57) ABSTRACT

Systems and methods for enhanced accounts are described. One described method comprises receiving at least one user identifier associated with a user, receiving a savings plan member number associated with the user and with at least one savings plan, and receiving purchase data associated with the at least one user identifier, the purchase data comprising a purchase amount. The method further comprises receiving a credit amount associated with the purchase amount, determining a deposit amount for the at least one savings plan based at least in part on the credit amount, and causing the deposit amount to be deposited in the at least one savings plan.

### CROSS-REFERENCE TO RELATED APPLICATIONS

This application claims the benefit of U.S. Provisional Application No. 60/488,245, filed Jul. 18, 2003, the entirety of which is hereby incorporated by reference.

### NOTICE OF COPYRIGHT PROTECTION

A section of the disclosure of this patent document and its figures contain material subject to copyright protection. The copyright owner has no objection to the facsimile reproduction by anyone of the patent document, but otherwise reserves all copyright rights whatsoever.

### FIELD OF THE INVENTION

The present invention relates generally to systems and methods for implementing accounts. The present invention relates particularly to systems and methods for enhanced accounts.

### BACKGROUND

Merchants and companies providing credit, debit, gift, pre-paid, loyalty, or other types of cards that involve, for example, tracking of purchase transactions, electronic transfers of funds, extensions of credit, or other account transactions (hereinafter “Card Companies”) offer a wide variety of enticements in an effort to attract customers. The enticements include both one-time gifts, such as clothing or airline mileage, and ongoing affinity or loyalty programs. For example, many card companies provide a rebate equal to a percentage of a customer's purchases. Other card companies contribute a percentage of the customer's purchases to an educational institute or charity.

More recently, loyalty and microinvesting companies as well as software licensees have tied the rebates into savings programs. For example, the Upromise college savings program (www.upromise.com) allows participants to accumulate dollars through the purchase of certain products and patronage of certain merchants and that such dollars are either accumulated in a non-529 college savings program, which is non-interest bearing, or is linked to a 529 plan account.

Conventional affinity and loyalty programs are inflexible and ill suited for certain groups of employees. Additionally, many conventional programs require a participant to provide a variety of personally identifying information, which increases the risk of identity theft and other forms of fraud made possible by the disclosure of the information. A flexible and secure system and method for an enhanced retirement savings account is needed.

### SUMMARY

Embodiments of the present invention provide systems and methods for enhanced accounts. One embodiment provides a method comprising receiving at least one user identifier associated with a user, receiving a savings plan member number associated with the user and with at least one savings plan, and receiving purchase data associated with the at least one user identifier, the purchase data comprising a purchase amount. The method further comprises receiving a credit amount associated with the purchase amount, determining a deposit amount for the at least one savings plan based at least in part on the credit amount, and causing the deposit amount to be deposited in the at least one savings plan. In another embodiment, a computer-readable medium (such as, for example random access memory or a computer disk) comprises code for carrying out such a method.

These embodiments are mentioned not to limit or define the invention, but to provide examples of embodiments of the invention to aid understanding thereof. Illustrative embodiments are discussed in the Detailed Description, and further description of the invention is provided there. Advantages offered by the various embodiments of the present invention may be further understood by examining this specification.

### BRIEF DESCRIPTION OF THE FIGURES

These and other features, aspects, and advantages of the present invention are better understood when the following Detailed Description is read with reference to the accompanying drawings, wherein:

FIG. 1 is a block diagram illustrating a exemplary environment for implementation of one embodiment of the present invention;

FIG. 2 is a flowchart illustrating the process according to one embodiment of the present invention from the customer's perspective;

FIG. 3 is a flowchart illustrating a method for receiving and storing the information used by one embodiment of the present invention;

FIG. 4 is a flowchart illustrating a method for receiving and disbursing funds in one embodiment of the present invention;

FIG. 5 is a flowchart illustrating a process for registering with a disbursement manager according to one embodiment of the present invention;

FIG. 6 is a flowchart illustrating a process for a rewards process according to one embodiment of the present invention;

FIG. 7 is a flowchart illustrating a process for the distribution of proceeds in one embodiment of the present invention; and

FIG. 8 is a flowchart illustrating a process for pre-tax processing in one embodiment of the present invention.

### DETAILED DESCRIPTION

Embodiments of the present invention provide systems and methods for providing an enhanced account, such as a retirement and/or savings benefit. In one embodiment, a merchant, or other product or service provider, registers with a savings plan disbursement manager. Users, such as customers or employees, also register with the disbursement manager, providing a user identifier, such as a card number or other identifiers, to the disbursement manager. In addition, each user (e.g., customer) identifies at least one savings plan to the disbursement manager to which funds are to be directed.

After the user makes a purchase from the merchant, the merchant makes purchase data available to the disbursement manager and transfers a credit amount associated with the purchase amount to the disbursement manager. The disbursement manager determines a deposit amount for the savings plan that is based, at least in part, on the credit amount. For example, the disbursement manager may determine a pre-tax equivalent of the credit amount to be deposited in the savings plan. The disbursement manager then causes the deposit amount to be deposited in the savings plan of the user.

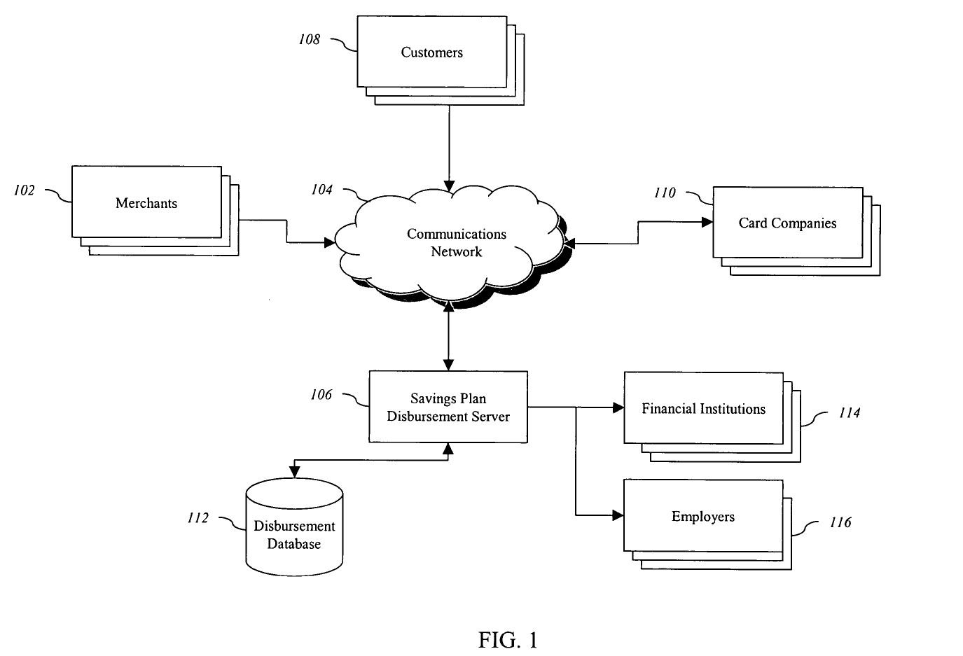

Referring now to the drawings in which like numerals indicate like elements throughout the several drawings, FIG. 1 is a block diagram illustrating an exemplary environment for implementation of one embodiment of the present invention. In the embodiment shown, one or more merchants 102 are in communication with a communications network 104, and through the communications network 104, with a savings plan disbursement server 106. The merchants 102 may be providers or goods or services. The merchants 102 may also be entities providing products or services to other merchants. For example one merchant may be a loyalty program management company.

The communications network 104 may comprise a public, private, or governmental network, such as the Internet, which allows computer systems to communicate using a standard or proprietary protocol. Alternatively, the communications network 104 may include a telephone network over which transactions are communicated.

Also in communication with the communications network 104 are one or more customers 108 and one or more card companies 110. Although depicted as customers 108 in the embodiment shown, the customers 108 may be any user of the system, including, for example, employees of a company, customers of a chain of grocery store, or other suitable users.

In the embodiment shown, the communications flows are depicted as one-way from the merchants 102 and consumers 108 to the communications network 106. However, in other embodiments, these communications flows are bi-directional. For example, the merchants 102 and customers 108 may receive reports or other information from the savings plan disbursement server 112.

The savings plan disbursement server 106 is in communication with a disbursement database 112. The disbursement server 106 stores and retrieves information in the database 112 related to the merchants 102, customers 108, card companies 110, and other information necessary to receive, store, and track data, disburse funds, and perform other functions related to embodiments of the present invention. The disbursement server 106 processes and provides data to financial institutions 114 and to employers 116.

In the embodiment shown, the disbursement server 116 is a computer. The computer includes software for providing a web interface to the customers 108 or other entities interacting with the disbursement server 106. For example, in one embodiment, customers 108 are able to access the disbursement server at any time from anywhere on the Internet to check the status of their account. In other embodiments, the disbursement server 106 may include additional hardware and software components and may also include manual processes integrated with computerized processes. For example, in one embodiment, the disbursement server 106 includes a telephone-access component (not shown), allowing customers 102 to check the status of their account or receive reports via a telephone or other suitable communication device.

In the embodiment shown, the computer on which the disbursement server 106 executes includes a processor. The processor executes computer-executable program instructions stored in memory. Such processors may comprise a microprocessor, an Application-specific Integrated Circuit (ASIC), a state machine, or other processor. Such processors comprise, or may be in communication with, media, for example computer-readable media, which stores instructions that, when executed by the processor, cause the processor to perform the steps described herein.

Embodiments of computer-readable media may comprise an electronic, optical, magnetic, or other storage or transmission device capable of providing a processor, such as the processor of the disbursement server 106, with computer-readable instructions. Other examples of suitable media may comprise a floppy disk, Compact Disk Read Only Memory (CD-ROM), magnetic disk, memory chip, Read Only Memory (ROM), Random Access Memory (RAM), an ASIC, a configured processor, all optical media, all magnetic tape or other magnetic media, or any other suitable medium from which a computer processor can read instructions or on which instructions, code, or other data may be stored. Also, various other forms of computer-readable media may transmit or carry instructions to a computer, including a router, private or public network, or other transmission device or channel, both wired and wireless. The instructions may comprise code from any suitable computer-programming language, including, for example, C, C++, C#, Visual Basic, Java, Python, Perl, and JavaScript.

Customers, merchants, employers, and others interacting with the system may utilize client devices (not shown). Client devices may also comprise a number of external or internal devices such as a mouse, a CD-ROM, a keyboard, a display, or other input or output devices. Examples of client devices are personal computers, media center computers, televisions, television set-top boxes, digital assistants, personal digital assistants, cellular phones, mobile phones, smart phones, pagers, digital tablets, laptop computers, Internet appliances, and other processor-based devices. In general, a client device may be any type of processor-based platform that may be connected to a network 104 and that interacts with one or more application programs. Client devices may operate on any operating system, such as Microsoft® Windows® or Linux, capable of supporting one or more client application programs. For example, the client device comprises a personal computer executing client application programs, also known as client applications. The client applications can be contained in memory 108 and can comprise, for example, a media player application, a closed captioning decoder application, a programming guide application, an e-mail application, an instant messenger application, a presentation application, an Internet browser application, a calendar/organizer application, a word processing application, a spreadsheet application, and any other application or computer program capable of being executed by a client device.

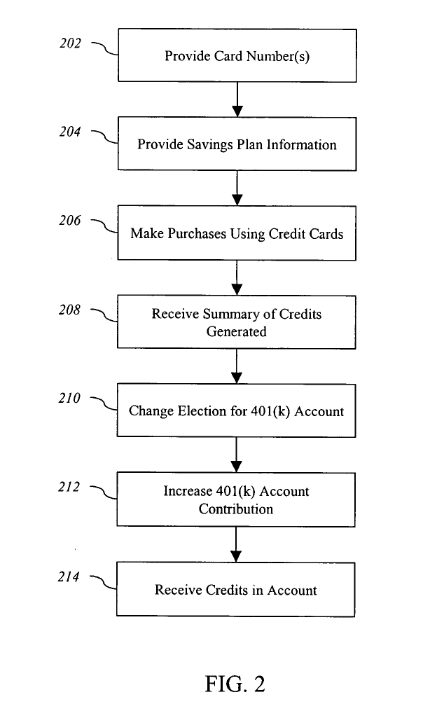

FIG. 2 is a flowchart illustrating the process according to one embodiment of the present invention from the customer's perspective. In the embodiment shown, the customer provides one or more card numbers to a disbursement manager 202. The customer or other user may use provide any type of identifier, including, for example any type of card or other purchase mechanism, a loyalty program member number, a social security number, or other suitable user identifier.

The customer also provides information about one or more savings plans to which rebates or credits from the previously identified card numbers are directed 204. For example, the customer or other user may be an employee of a company and participate in the employer's 401(k) savings program. The user identifies this program, for example, by selecting it from a list on a user interface. The user may perform additional tasks as well, such as specifying that only a portion of any amounts are directed to a particular savings plan. The user may identify more than one savings program. The user may also access the list of elected savings programs to make additions, deletions, or modifications.

Once the customer has provided the card information (e.g., credit, debit, and/or frequent shopper card information), the customer makes purchases using the registered card numbers 206. For example, the customer makes purchases at a grocery store and uses the card, such as a credit card or a loyalty card, or otherwise identifies herself to the merchant.

For each purchase with the card or that qualifies for the loyalty program, the customer receives a rebate or credit. For example, a user may receive a 1% credit for every purchase made at a participating merchant. Participating merchants, coupons, loyalty program service providers, or other sources may also provide the credits. In the embodiment shown in FIG. 2, at the end of a period, e.g., a month or a year, the customer receives a summary of the credits received 208. The customer may receive additional information as well, such as a detailed transaction report.

The customer or a service provider utilizes the summary report or other provided information to determine a deposit amount. The deposit amount is based, at least in part, on the credit amount from the merchant. For example, the deposit amount may be a pre-tax equivalent of the credit amount, a portion of the credit amount, or otherwise based on the credit amount and other factors. The customer uses the information to make a one-time election change in the amount deposited for the customer in the customer's savings plan, such as in the customer's 401(k) plan 210.

For example, in one embodiment, the customer accesses a benefits web site to view and modify information related to the customer's 401(k) account. One option presented to the customer, or other user, is to make changes to elections of amounts to be deposited in the 401(k) account. The customer may make an election change equal to the deposit amount. The change in election results in a change in the amount deposited in the customer's 401(k) account, i.e., an increase in the contribution amount 212. The customer enjoys the benefits of an increased payroll deduction offset by a distribution of benefits.

The rebates or credits are provided to the customer in one or more of the customer's accounts, such as a savings or checking account 214. For example, the customer may have an effective overall income tax rate of approximately 40%. In other words, for every $100 pre-tax dollars the customer is paid, the customer receives $60 in her account. Accordingly, if the customer receives information indicating that the customer is eligible for a $60 rebate, the customer may elect to have an additional $100 deposited in a pre-tax 401(k) account, realizing that the combination of changes will result in a 0$ net change in the customer's income for the period. In this manner, the customer is able to maximize the amount of pre-tax dollars deposited in the 401(k) account without experiencing any decrease in her income. In one embodiment, funds are only deposited in interest-bearing accounts. In another embodiment, funds may be deposited in any of the customer's accounts.

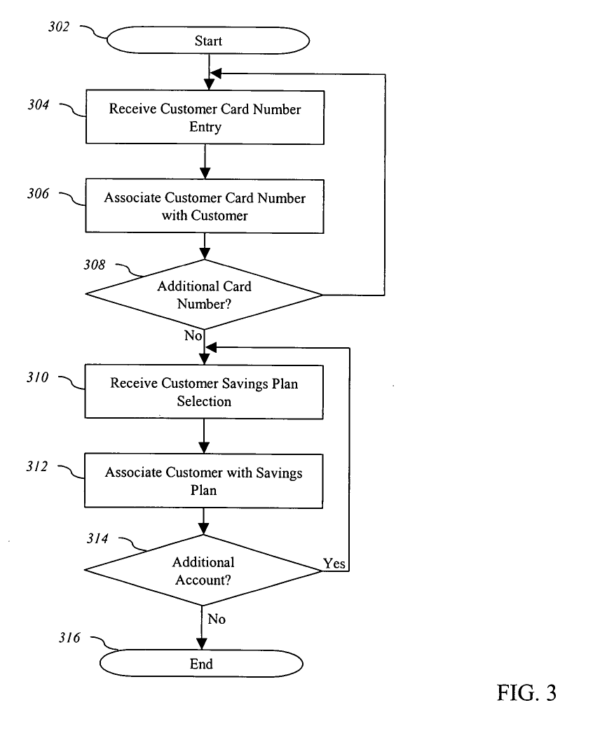

FIG. 3 is a flowchart illustrating a method for receiving and storing the information used by one embodiment of the present invention. In the embodiment shown, the process starts 302, and the consumer (104) accesses a user interface, for example, by accessing a web-based interface generated by the disbursement server (106). The customer is identified by the system. For example, the customer may enter a username/password combination. Alternatively, the system may identify the customer based on an authentication scheme present on the customer's client device (e.g., the credentials that a user uses to log on to a local area network).

Once the customer has accessed the interface, the customer enters a user identifier, such as a loyalty card number or a card number. The user identifier may identify another type of a card, such as a pharmacy discount card, any other affinity program, or any other suitable program. In the embodiment shown, the customer need not enter any additional information about the card, such as the expiration date. By limiting the amount of information the customer provides, the likelihood of identity theft and other forms of fraud related to the card information is substantially reduced. In addition, the confidence of the customer in the security of the system is enhanced. In other embodiments, the customer may enter additional information. Referring still to FIG. 3, the disbursement server (106) receives the entry 304.

The disbursement server (106) next associates the customer card number with the customer 306. For example, the disbursement server (106) may store the user identifier in a table in the disbursement database (112).

The disbursement server (106) determines whether or not additional card numbers are to be associated with the customer 308. For example, the disbursement server (106) may present the customer with an option of entering additional identifiers. Alternatively, the customer may be presented with multiple entry fields in the user interface in which to enter identifiers. If additional identifiers are to be associated with the customer, the disbursement server (106) repeats the steps 304 and 306 of the process.

If no additional card numbers are received, the disbursement server (106) receives customer savings plan selections 310. The savings plan selections include an identifier of a savings plan to which funds are directed and may include additional information, such as the percentage of each disbursement that is directed to each savings plan account.

The disbursement server (106) associates the savings plan information with the customer 312. For example, the disbursement server (106) may store the data in the disbursement database (112) on in another data store or memory.

Referring still to FIG. 3, the disbursement (106) server next determines whether additional account information has been received 314. If so, the disbursement server (106) repeats steps 310 and 312 for each account. If not, the process shown ends 316.

For example, a customer may choose to have thirty percent of the funds directed to fund X with mutual fund provider A, thirty percent directed to fund Y with mutual fund provider A, and forty percent directed to mutual fund Z with mutual fund provider B. Alternatively, a customer may choose to have fifty percent directed to an IRA account and fifty percent to a savings account. An almost infinite number of variations for directing the funds are possible.

Although the process illustrated in FIG. 3 shows the receipt of user identifiers and savings plan selections as discreet steps. They may occur substantially simultaneously or in a different order. For instance, the user interface may include multiple sections on a single form that allow a user to select user identifiers and savings accounts, enter allocation amounts, and provide other information. When the user has entered all of the information, the user clicks a “Submit” button that causes the information to be transmitted to the disbursement server (106).

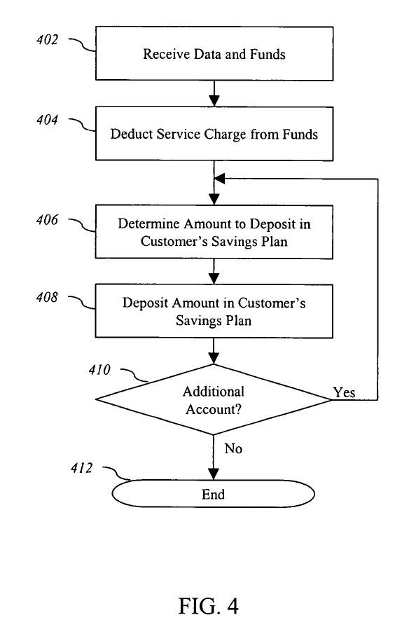

FIG. 4 is a flowchart illustrating a method for receiving and disbursing funds in one embodiment of the present invention. In the embodiment shown, a customer's account is reconciled periodically, e.g., monthly or quarterly. During the period between each reconciliation, the disbursement manager receives data and funds from various entities, including, for example, retail merchants, service providers, and credit/debit card companies at the disbursement server (106) 402.

The data includes at least the card number and the amount of funds to be transferred. The data may include additional information, such as date of purchases, an identifier of the merchant, and other information regarding the purchases. The funds may be actually transferred to accounts managed by the disbursement center or may comprise some type of authorization to extract funds from an account.

Upon reconciliation, the disbursement server (106) deducts a service charge from the funds received 404. The service charge may be a flat rate or a percentage of the funds for a particular customer. The service charge may be derived in other ways as well. For instance, the service charge may be based on the number of user identifiers, savings accounts, transactions, or other suitable measures. In another embodiment, the disbursement manager charges a retail merchant an administrative fee separate from the invoice for the investment rewards.

Of the remaining funds, the disbursement server (106) next determines the percentage to deposit into a customer's particular account 406. For example, when the customer accesses the user interface, the customer may specify that certain percentages of the total credit amount for a period be deposited in a particular one or more savings plans. When the user submits the allocations, the disbursement server (106) saves the information in the disbursement database (112).

The disbursement server (106) then deposits this amount into the account at the financial institution (114) 408. The disbursement server (106) may accomplish this be sending a transfer request to another system, such as a financial services company's system, by executing an electronic transfer, or by some other suitable transfer means.

In the embodiment shown in FIG. 4, the two steps 406, 408 are repeated for each account that a customer has selected or otherwise identified (e.g., through the process illustrated in FIG. 3) 410. Once funds have been disbursed to each specified account, the process ends 412.

In another embodiment, the funds are deposited in an account of the employer (116). At the end of the next pay cycle, the employer deposits funds into the employee's savings account equal to the funds received from the disbursement server (106). The funds from the disbursement server (106) are deposited in the employee's account. In this way, the employee receives the benefit of the rebates as an additional deposit in their 401(k) or other account, while seeing little or no change in the amount of their income. By utilizing such an embodiment, the employee may also be able to take advantage of additional tax-deferred savings. For example, if the deposit is from the employer to the 401 (k) plan, the employee may be able to defer the taxes in the same manner as with any employer 401(k) deposit. Similar benefits may be utilized with other types of accounts.

In the embodiments shown, rebates are described as issuing from card companies. However, a rebate may be issued by a variety of sources, including, for example, retail merchants, banks, coupon issuers, and brand owners. For example, in one embodiment, a brand owner begins a promotion for a laundry detergent. The customer visits a participating merchant and purchases the laundry detergent. During a periodic accounting, the disbursement server (106) determines that the customer shopped at a participating merchant. The disbursement server (106) searches the database (112) to determine the percentage of the purchase or fixed dollar amount that the merchant will provide as a rebate. The disbursement server (106) also searches the database (112) to determine the percentage of the purchase or fixed dollar amount that the brand owner will provide as a rebate.

In one embodiment of the present invention, merchants (102) register with the disbursement manager. The merchants (102) are then able to access reports and other information on the savings plan disbursement server (106). In one embodiment, the merchants are able to access only reports and information containing aggregated data; no data capable of personally identifying a customer is provided. In another embodiment, the merchant is provided with detailed information, which may personally identify a customer. The merchants (102) may register at the outset of the program or at other times after the program has begun. In one embodiment, the merchant receives funds for participating in the program. In other embodiments, the merchant receives no funds.

In an alternative embodiment of the present invention, the savings plan disbursement server (106) includes a coupon engine. The customers (102) are able to access a user interface generated by the disbursement server (106) and print a coupon tied to an account to which funds have been deposited. The coupon is then used for discounts at participating merchants. In another embodiment, the customers (102) are able to print a rebate check or other negotiable instrument directly from their home computer.

One embodiment of the present invention is an enhanced retirement benefits system for state employees. In such an embodiment, a disbursement manager provides a program in which State employees receive rebates from their patronage of certain merchants. The disbursement manager collects rebates on behalf of the employees and the employee receive the rebates as cash or as deposits that may be used for the benefit of a pre-tax savings account, such as the State 401(k), 403(b) or 457 plan, a healthcare savings account (“HSA”), a 529 education savings plan, or any other pre-tax account.

The disbursement manager may directly deposit program accumulations in a specified account or may periodically advise an employee of the amount accumulated on the employee's behalf under the program so that the employee can make changes to the contributions amount directed to the employee's 401(k), 403(b), 457, and/or HSA plan. In the latter case, the disbursement manager periodically deposits the amounts into the employee's regular savings account, pursuant to the direction of the employee. The timing of the contribution changes are dependent on state and federal regulations and therefore embodiments of the present invention may be directed at only one state or may include logic to vary the rules based on varying state regulations. In an alternative embodiment, the employer advises the employee of the amount of the rebates and provides that amount to the employee as a cash disbursement, distributing a check directly to the employee. In one embodiment, the disbursement manager provides a one-time update to a savings-plan administrator for making changes to an employee's payroll contributions.

In one embodiment, at the end of the year, a disbursement manager assists an employee in maximizing the benefit of the savings received throughout the year. The disbursement manager examines data stored in the disbursement database (112) to determine the total dollar amount of rebates or other benefits that the employee has received. The disbursement manager then evaluates the employee's pre-tax contribution to determine the exact amount that the employee could set aside to maximize the employee's pre-tax contribution to a pre-tax savings account (e.g., 401(k) account).

For example, in an embodiment a state employee generates two hundred and seventy-five dollars during the year. At the end of the year, the state informs the employee of the amount and suggests that the employee make an election to increase the employee's contribution by two hundred and seventy-five dollars on the last paycheck of the year. The state then makes the additional contribution to the employee's account based on the election and includes the two hundred and seventy-five dollars earned through the program in the employee's check. The result is that the employee's income remains unchanged while the employee's savings account has increased by two hundred and seventy-five dollars. The employee maximizes the benefits of a pre-tax savings account without experiencing a reduction in his or her income.

In other embodiments, the employer implements the system in a manner that is transparent to the employee. For example, in one such embodiment, the employer has access to the savings account throughout the year. As the employee earns credits, the employer varies the employee's contributions to a savings account in order to maximize the employee's benefit. For example, in one month, the employee receives one hundred dollars in credits. The employer increases the employee's contribution to the savings account by one hundred dollars and applies the credits to the employee's savings or checking account. The net amount of the employee's income does not change. If during the next month the employee earns more or less credits, the employer again changes the employee's contribution to the account so that the credits and the change to the savings plan contribution are equal, resulting in no net effect to the amount the employee receives in a that month's income. In such an embodiment, the employee is able to maximize the benefit of the program without having to take additional action.

In another embodiment, a private employer utilizes the system to provide an enhanced retirement savings account to its employees. As with an embodiment implemented by a state employer, the private employer may include a variety of options for the employees and participating merchants.

The disbursement manager may derive income from various sources in an embodiment of the present invention. For example, in one embodiment, the customers 108 are presented with advertisements for participating merchants, sponsors, service providers, or other advertisers while they access a web interface. The disbursement manager charges a per-instance fee each time an advertisement is displayed. The disbursement manager may charge additional click-through fees as well.

Embodiments of the present invention provide numerous advantages over conventional savings programs. For example, embodiments of the present invention encourage employees to save additional funds in savings accounts, especially in pre-tax savings accounts. Embodiments of the present invention also encourage patronage of participating merchants by employees taking advantage of the program. Embodiments of the present invention also provide an income source to the disbursement manager. Further advantages and benefits are described above.

### Illustrative Embodiments

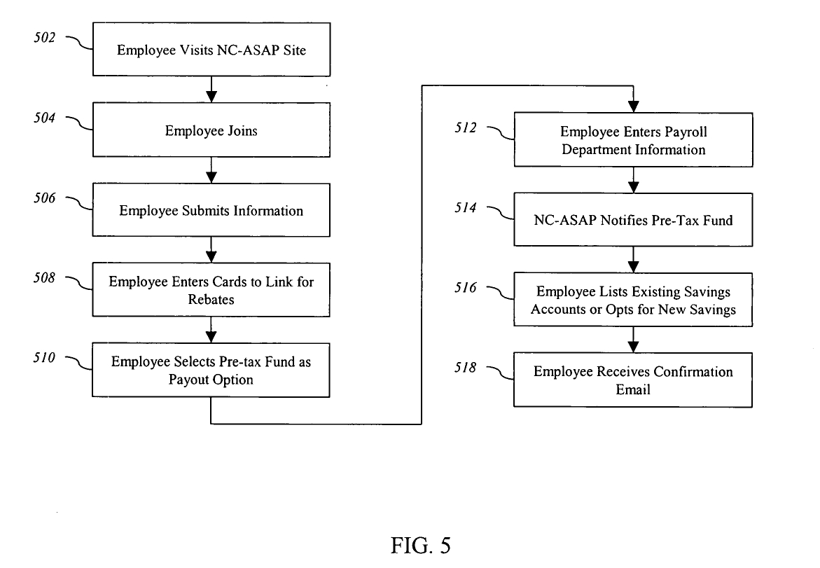

FIG. 5 is a flowchart illustrating a process for registering with a disbursement manager according to one embodiment of the present invention. In the embodiment shown, the employee visits the NC-ASAP site to enroll 502. In another embodiment, the employee may use another means to enroll, such as a toll-free telephone number. The employee lists personal contact or other information by clicking a join link and filling out a form 504. When the employee clicks a submit button, the information is submitted 506.

The employee then lists card information, such as debit and credit cards (without expiration dates, security codes, or PIN numbers), to track transactions 508. The employee then selects a pre-tax fund as a payout option 510. For example, in one embodiment, the employee designates a North Carolina 401K program as the beneficiary of the savings benefit. The employee then enters the contact information for her payroll department 512. NC-ASAP notifies the pre-tax fund/deferred compensation service (“DSC”), including the sub-plan number 514. In one embodiment, the NC-ASAP provides new employers and payroll departments with instructions about implementation of employee deduction at the periodic (e.g., annually) disbursement event.

The employee then list existing savings accounts or opts for a new one 516. A confirmation email is sent to the employee 518. The signup process is now complete. In one embodiment, NC-ASAP delivers to the NC 401K/DCS a batch file annually of employee elections, including the employee's social security number, sub-plan number, and the value of the distributions.

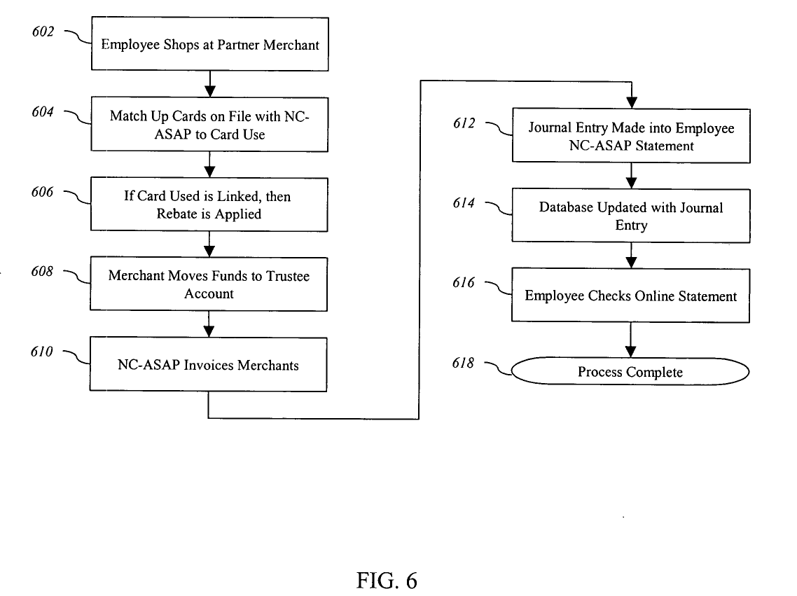

FIG. 6 is a flowchart illustrating a process for a rewards process according to one embodiment of the present invention. In the embodiment shown, an employee shops at a partner merchant, either in the store or online (e.g., a merchant in the NC-ASAP merchant network) 602. The merchant makes transaction information available to NC-ASAP, and the cards on file with NC-ASAP are matches up with transactions 604. If a card that is used matches a card on file, then a rebate is applied 606. The merchant moves the funds to a trustee account 608.

In the embodiment shown in FIG. 6, NC-ASAP then invoices the merchant 610. A corresponding journal entry is made in the employee's NC-ASAP statement 612, and a database is updated with the journal entry 614. The information is then available to the employee, e.g., by checking an online statement or via email 616. The rewards process is then complete 618.

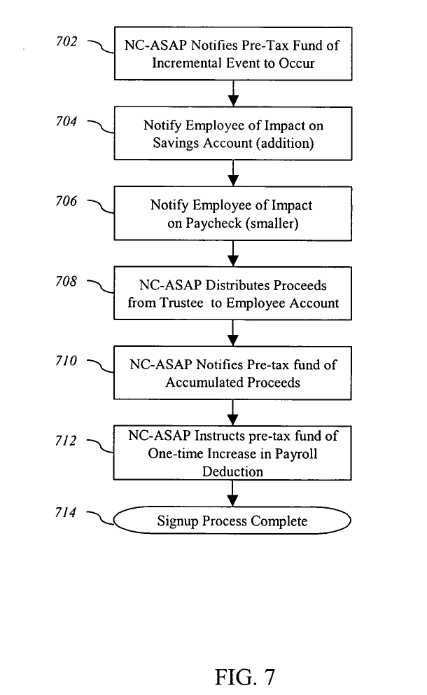

FIG. 7 is a flowchart illustrating a process for the distribution of proceeds in one embodiment of the present invention. In the embodiment shown, the disbursement manager (e.g., NC-ASAP) notifies the pre-tax fund/DCS of an incremental event to occur 702. The fund or NC-ASAP then notifies the employee of the impact on the savings account (i.e., addition) 704. The employee is also notified of the impact on her paycheck (i.e., decrease) 706.

NC-ASAP distributes proceeds form a trustee account to the employee's savings plan 708. For example, in one embodiment, NC-ASAP makes an annual distribution. NC-ASAP also notifies the pre-tax fund/DCS of the accumulated proceeds 710. NC-ASAP, on behalf of the employee, then instructs the pre-tax fund/DCS of a one-time increase in payroll deduction 712. The process for distribution of proceeds shown in FIG. 7 then ends 714.

In one embodiment, the employee has the opportunity to update savings plan options or to designate other plans to receive proceeds from NC-ASAP. For example, the employee may access the NC-ASAP site or call a toll-free number to make any changes. In one embodiment, once an annual election is made, no changes are accepted unless a family status has occurred. Also, no further employee confirmation may be sent once the annual election is made.

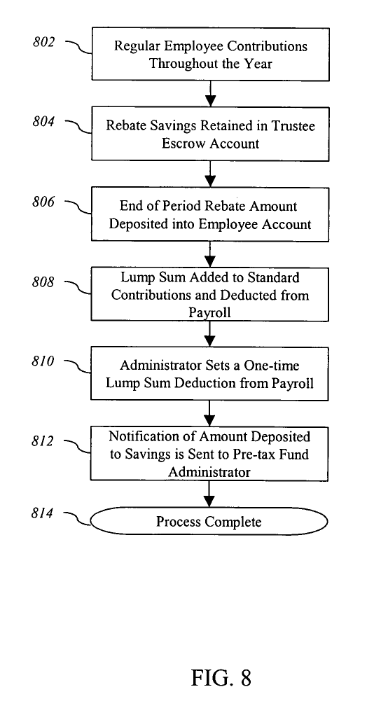

FIG. 8 is a flowchart illustrating a process for pre-tax processing in one embodiment of the present invention. In the embodiment shown, regular employee contributions are made throughout the year 802. Rebate savings are kept in a trustee escrow account 804. At the end of the fiscal year, a rebate amount is deposited in an employee's savings account 806.

Notification of the amount deposited to the savings account is sent to a pre-tax fund administrator 808. The administrator sets a one-time lump sum deduction from the employee's payroll 810. The lump sum is added to the employee's standard contributions and is deducted from the employee's payroll 812. The process then ends 814.

The foregoing description of the preferred embodiments of the invention has been presented only for the purpose of illustration and description and is not intended to be exhaustive or to limit the invention to the precise forms disclosed. Numerous modifications and adaptations thereof will be apparent to those skilled in the art without departing from the spirit and scope of the present invention.

1. A method comprising:
receiving at least one user identifier associated with a user;
receiving a savings plan member number associated with the user and with at least one savings plan;
receiving purchase data associated with the at least one user identifier, the purchase data comprising a purchase amount;
receiving a credit amount associated with the purchase amount;
determining a deposit amount for the at least one savings plan based at least in part on the credit amount; and
causing the deposit amount to be deposited in the at least one savings plan.

2. The method of claim 1, wherein causing the deposit amount to be deposited in the saving plan comprises changing a payroll deduction amount.

3. The method of claim 1, further comprising causing the credit amount to be added to an account.

4. The method of claim 3, wherein the account comprises an interest-bearing account.

5. The method of claim 1, wherein determining the deposit amount for at least one the savings plan comprises calculating a pre-tax equivalent of the credit amount.

6. The method of claim 1, wherein the user is an employee.

7. The method of claim 1, wherein the user is a customer.

8. The method of claim 1, further comprising receiving a service charge from at least one of a merchant and a card company.

9. The method of claim 1, wherein at least one the savings plan comprises a plurality of savings plans.

10. The method of claim 9, wherein each of the plurality of savings plans is associated with a credit allocation percentage and the deposit amount is determined based at least in part on the credit allocation percentage.

11. The method of claim 1, wherein the at least one user identifier comprises a card number associated with a member card.

12. The method of claim 11, wherein the member card comprises one of a loyalty card and a credit card.

13. The method of claim 1, wherein the at least one user identifier comprises a loyalty program participant number.

14. The method of claim 1, wherein the at least one user identifier comprises a plurality of user identifiers.

15. The method of claim 1, wherein the at least one user identifier comprises a card number.

16. The method of claim 1, wherein at least one the savings plan comprises one of a 401(k) plan, a 403(b) plan, a 457 plan, a healthcare savings account, and a 529 plan.

17. The method of claim 1, further comprising:
receiving a request for a status report associated with one or more of the at least one user identifier and the at least one savings plan;
generating the status report; and
outputting the status report.

18. A computer-readable medium on which is encoded program code, the program code comprising:
program code for receiving at least one user identifier associated with a user;
program code for receiving a savings plan member number associated with the user and with at least one savings plan;
program code for receiving purchase data associated with the at least one user identifier, the purchase data comprising a purchase amount;
program code for receiving a credit amount associated with the purchase amount;
program code for determining a deposit amount for the at least one savings plan based at least in part on the credit amount; and
program code for causing the deposit amount to be deposited in the at least one savings plan.

19. The computer-readable medium of claim 18, wherein program code for causing the deposit amount to be deposited in the saving plan comprises program code for changing a payroll deduction amount.

20. The computer-readable medium of claim 18, further comprising program code for causing the credit amount to be added to a to an account.

21. The computer-readable medium of claim 18, wherein program code for determining the deposit amount for at least one the savings plan comprises program code for calculating a pre-tax equivalent of the credit amount.

22. The computer-readable medium of claim 18, further comprising program code for receiving a service charge from at least one of a merchant and a card company.

23. The computer-readable medium of claim 18, wherein at least one the savings plan comprises a plurality of savings plans.

24. The computer-readable medium of claim 23, wherein each of the plurality of savings plans is associated with a credit allocation percentage and the deposit amount is determined based at least in part on the credit allocation percentage.

25. The computer-readable medium of claim 18, further comprising:
program code for receiving a request for a status report associated with one or more of the at least one user identifier and the at least one savings plan;
program code for generating the status report; and
program code for outputting the status report.
